(19) United States
(12) Patent Application Publication
(10) Pub. No.: US 2025/0087740 A1
(43) Pub. Date: Mar. 13, 2025

(54) METHOD FOR MANUFACTURING SODIUM-ION RECHARGEABLE BATTERY

(71) Applicant: Zhejiang Jinko Energy Storage Co., Ltd., Haining City (CN)

(72) Inventors: Jing CHEN, Haining City (CN); Zixiang YANG, Haining City (CN); Yi LUO, Haining City (CN)

(21) Appl. No.: 18/957,539

(22) Filed: Nov. 22, 2024

(30) Foreign Application Priority Data
Nov. 7, 2024 (CN) 202411587723.6

(51) Int. Cl. H01M 10/054; H01M 4/02; H01M 4/133; H01M 4/134; H01M 4/136; H01M 4/38; H01M 4/583; H01M 10/0567; H01M 10/058; H01M 10/42; H01M 10/44

(52) U.S. Cl. CPC H01M 10/054; H01M 4/133; H01M 4/134; H01M 4/136; H01M 4/38; H01M 4/583; H01M 10/0567; H01M 10/058; H01M 10/4235; H01M 10/446; H01M 2004/027; H01M 2004/028

(57) ABSTRACT

Embodiments of the present disclosure relate to the field of energy storage and provide a method for manufacturing sodium-ion rechargeable batteries. The method includes: providing a cell and disposing the cell inside a casing; performing a first injection operation on the cell disposed inside the casing using a first electrolyte, where the first electrolyte includes: 1,3-propanesultone of 0.5 wt % to 2 wt %, tris(trimethylsilyl) phosphate of 0.1 wt % to 2 wt %, fluoroethylene carbonate of 0.1 wt % to 2 wt %, a film forming additive of 0.01 wt % to 5 wt %, and at least one sodium salt; performing infiltration treatment and pre-charging treatment; performing a second injection operation on the cell disposed inside the casing using a second electrolyte, where the second electrolyte includes: 1,3-propanesultone of 5 wt % to 20 wt %, a nitriles compound of 3 wt % to 30 wt %, a water and acid removing additive of 0.005 wt % to 30 wt %, and at least one sodium salt; and allowing the cell to stand.

### CROSS REFERENCE TO RELATED APPLICATIONS

The present application claims the benefit of priority under the Paris Convention to Chinese Patent Application No. 202411587723.6 filed on Nov. 7, 2024, which is incorporated herein by reference in its entirety.

### TECHNICAL FIELD

Embodiments of the present disclosure relate to the field of energy storage, and in particular to a method for manufacturing sodium-ion rechargeable batteries.

### BACKGROUND

At present, lithium-ion batteries occupy the core position of power batteries. However, usage of the lithium-ion batteries faces great challenges, such as the increasing scarcity of lithium resources, rising prices of materials, and low recycling rates of old batteries.

The sodium-ion batteries and the lithium-ion batteries have similarities in principle and structure. However, compared with the lithium-ion batteries, the sodium-ion batteries have a plurality of unique advantages. Firstly, sodium is abundant in the Earth's crust, far exceeding lithium, making the supply of resources for the sodium-ion batteries more abundant. Secondly, the production cost of the sodium-ion batteries is relatively low, and the fluctuation of prices of the raw materials is small, making the sodium-ion batteries more stable in market competition. In addition, the sodium-ion batteries can work over a wider temperature range and have higher safety, which makes the sodium-ion batteries perform well in various application scenarios. These advantages make the sodium-ion batteries a good supplement to the lithium-ion batteries in specific application scenarios, and even replace the lithium-ion batteries in some aspects. For example, in large-scale energy storage systems, the sodium-ion batteries are particularly suitable due to their cost-effectiveness and safety advantages.

Therefore, promoting the research and development of high-performance and low-cost sodium-ion batteries has become a key point in achieving large-scale industrialization of the sodium-ion batteries. The sodium-ion batteries can be widely accepted in the market only by improving the energy density, cycle life, and safety of the sodium-ion batteries.

### SUMMARY

Embodiments of the present disclosure provide a method for manufacturing sodium-ion rechargeable batteries, which is at least conducive to addressing the problems of gas generation under high temperature, high impedance, and poor performance in recycle of the sodium-ion batteries.

Some embodiments of the present disclosure provide a method for manufacturing sodium-ion rechargeable batteries, including: providing a cell and disposing the cell inside a casing; performing a first injection operation on the cell disposed inside the casing using a first electrolyte, where the first electrolyte includes: 1,3-propanesultone of 0.5 wt % to 2 wt %, tris(trimethylsilyl) phosphate of 0.1 wt % to 2 wt %, fluoroethylene carbonate of 0.1 wt % to 2 wt %, a film forming additive of 0.01 wt % to 5 wt %, and at least one sodium salt; performing infiltration treatment and pre-charging treatment; performing a second injection operation on the cell disposed inside the casing using a second electrolyte, where the second electrolyte includes: 1,3-propanesultone of 5 wt % to 20 wt %, a nitriles compound of 3 wt % to 30 wt %, a water and acid removing additive of 0.005 wt % to 30 wt %, and at least one sodium salt; and allowing the cell to stand. The cell includes a cathode plate, an anode plate, and an isolating membrane disposed between the cathode plate and the anode plate. The cathode plate, the isolating membrane, and the anode plate are stacked to form the cell, or the cathode plate, the isolating membrane, and the anode plate are stacked and wound to form the cell. The cathode plate includes a cathode current collector and at least one cathode active material layer disposed on the cathode current collector, and the anode plate includes an anode current collector and at least one anode active material layer disposed on the anode current collector. The at least one cathode active material layer includes a layered oxide cathode material, a polyanionic cathode material, or Prussian blue cathode material, and the at least one anode active material layer includes a metal compound, a carbon-based material, an alloy material, or a non-metallic simple substance.

In some embodiments, mass of the 1,3-propanesultone in the second electrolyte and mass of the 1,3-propanesultone in the first electrolyte meets: 40%×M≤m1≤50%×M, 50%×M≤m2≤60%×M, and M=m1+m2. Herein m1 refers to the mass of the 1,3-propanesultone in the first electrolyte, and m2 refers to the mass of the 1,3-propanesultone in the second electrolyte.

In some embodiments, the second electrolyte includes the nitriles compound of 10 wt % to 25 wt % and the water and acid removing additive of 5 wt % to 10 wt %.

In some embodiments, the nitriles compound includes a dinitriles compound, a trinitriles compound, an unsaturated nitriles compound, an aromatic-ring-containing nitriles compound, an alkoxynitriles compound, a sulfonyl-containing nitriles compound, or a trimethylsilyl-containing nitriles compound.

In some embodiments, the dinitriles compound includes succinonitrile, adiponitrile, glutaronitrile, suberonitrile or sebaconitrile; the trinitriles compound includes 1,3,6-hexanetricarbonitrile or 1,3,5-pentanetetricarbonitrile; the unsaturated nitriles compound includes acrylonitrile, crotononitrile, trans-butenedinitrile, or 1,4-dicyanobutene; the aromatic-ring-containing nitriles compound includes 4-fluorobenzonitrile, 4-methylbenzonitrile, or tricyanobenzene; the alkoxynitriles compound includes 1,2-di(cyanoethoxy)ethane, or 1,2,3-tris(cyanoethoxy)propane; the sulfonyl-containing nitriles compound includes sulfolane dinitrile; and the trimethylsilyl-containing nitriles compound includes 3-(trimethylsilyloxy)propionitrile.

In some embodiments, the water and acid removing additive includes a carbodiimide compound, a silazane compound, an amine compound, methanesulfonyl chloride, tetrahydrofuran, or trifluoroacetic anhydride.

In some embodiments, the carbodiimide compound includes dicyclohexylcarbodiimide or diisopropylcarbodiimide; the silazane compound includes hexamethyldisilazane, heptamethyldisilazane, or trimethylchlorosilane; and the amine compound includes triethylamine or diethylamine.

In some embodiments, a ratio of mass of the first electrolyte to a sum of the mass of the first electrolyte and mass of the second electrolyte ranges from 65% to 90%.

In some embodiments, the infiltration treatment includes a first infiltration stage and a second infiltration stage, a temperature for the first infiltration stage is greater than a temperature for the second infiltration stage, and a duration of the first infiltration stage is less than a duration of the second infiltration stage. The temperature for the first infiltration stage ranges from 40° C. to 50° C., and the duration of the first infiltration stage ranges from 10 h to 15 h. The temperature for the second infiltration stage ranges from 15° C. to 25° C., and the duration of the second infiltration stage ranges from 20 h to 30 h.

In some embodiments, the pre-charging treatment includes: performing constant-current charging at a charging rate ranged from 0.04 C to 0.06 C; and ending the pre-charging treatment at a voltage of 3.4V.

In some embodiments, during the pre-charging treatment, the method further includes: performing gas extraction from the casing.

In some embodiments, the first electrolyte includes the film forming additive of 0.5 wt % to 3 wt %.

In some embodiments, the second electrolyte further includes a functional additive of 0 wt % to 2 wt %, and the functional additive includes the film forming additive or a gas inhibiting additive.

In some embodiments, the functional additive includes at least one of sodium difluorooxalatoborate, sodium difluorophosphate, sodium bis(oxalato)borate, methane disulfonate, ethylene sulfate, triallyl phosphate, tripropargyl phosphate, 1,3-propene sultone, fluorobenzene, trifluoroethoxyvinyl carbonate, 2-methyl maleic anhydride, di-fluoro ethylene carbonate, succinic anhydride, tris(trimethylsilyl) phosphate, ethylene sulfite, or 1,6-diisocyanatohexane hexamethylene diisocyanate.

In some embodiments, the at least one sodium salt is select from a group of: sodium hexafluorophosphate, sodium perchlorate, sodium tetrafluoroborate, sodium hexafluoroarsenate, sodium tetrachloroaluminate, sodium trifluoroacetate, sodium tetraphenylborate, sodium difluorophosphate, sodium bis(oxalato)borate, sodium difluorooxalatoborate, sodium trifluoromethanesulfonate, sodium bis(fluorosulfonyl)imide, and sodium bis(trifluoromethanesulfonyl)imide.

In some embodiments, the isolating membrane includes at least one of polypropylene, polyethylene, ceramic coating, or non-woven fabrics.

### BRIEF DESCRIPTION OF THE DRAWINGS

One or more embodiments are exemplarily illustrated in reference to corresponding accompanying drawing(s), and these exemplary illustrations do not constitute limitations on the embodiments. Unless otherwise stated, the accompanying drawings do not constitute scale limitations. In order to illustrate the technical solutions in related technologies or in the embodiments of the present disclosure more clearly, the drawings to be used in the description of the embodiments will be briefly described below. It is obvious that the drawings mentioned in the following description are only some embodiments of the present disclosure. For those of ordinary skill in the art, other drawings may also be obtained in accordance with these drawings without any inventive effort.

FIG. 1 is a flow chart of the method for manufacturing sodium-ion rechargeable batteries provided in some embodiments of the present disclosure.

FIG. 2 is a schematic diagram of a structure of a cell of a sodium-ion rechargeable battery provided in some embodiments of the present disclosure. In FIG. 2, the second injection operation has been performed on the cell.

### DETAILED DESCRIPTION OF THE EMBODIMENTS

It is known from background that the lithium-ion batteries using lithium iron phosphate have been widely used in the field of energy storage due to their low cost and long cycle life. In the development process, the sodium-ion batteries still have many problems, especially the generation of gases under high temperature and poor performance in recycle.

Embodiments of the present disclosure provide a method for manufacturing sodium-ion rechargeable batteries. The method provides a solution based on two injection operations of electrolytes with different composition. In the method, 1,3-propanesultone and fluoroethylene carbonate are used as basic additives, amount of the basic additives in the first-injected electrolyte (i.e. the first electrolyte) is adjusted, and film forming additive is added into the first electrolyte, thereby forming solid electrolyte interface (SEI) films that distribute uniformly and have low polarization and low internal resistance after the first injection operation performed first. The 1,3-propanesultone provided in the second injection operation performed subsequently can be used as the additive for the subsequent long-term circulation, and is configured for fine repair of SEI films. The nitriles solvent and the water and acid removing additive provided in the second injection operation are conducive to inhibiting generation of gas and removing the water and acid in the electrolytes, thereby reducing the gas generated by the reaction between these impurities and other composition, and effectively suppressing the generation of gas during long-term cycling or under high temperature.

The technical solutions provided in the embodiments of the present disclosure have at least the following advantages.

In the method for manufacturing sodium-ion rechargeable batteries provided in the embodiments of the present disclosure, after disposing the cell inside the casing, a double-injection solution including the first injection operation and the second injection operation is adopted. The electrolyte provided in the first injection operation includes, in addition to the at least one sodium salt and the film forming additive, tris(trimethylsilyl) phosphate (TMSP) of 0.1 wt % to 2 wt %, fluoroethylene carbonate (FEC) of 0.1 wt % to 2 wt %, and 1,3-propanesultone (PS) of 0.5 wt % to 2 wt %, and the pre-charging treatment is performed after the first injection operation. FEC has a standard decomposition potential lower than that of PS, therefore stable SEI films can be formed first during the pre-charging treatment. The standard decomposition potential of PS is higher than that of TMSP, therefore PS can provide protection for the SEI films formed based on FEC, thereby facilitating the formation of dense and uniform SEI films with low impedance on the anode, and being conducive to improvement of the performance and life of batteries in high-temperature storage and cycling. TMSP, as a typical film forming additive for cathodes, is mainly used to protect the cathode and form a stable cathode interface with low impedance during the pre-charging treatment, which is conducive to improvement of performance in recycle. After the pre-charging treatment, the second injection operation is performed. The second electrolyte provided in the second injection operation includes 1,3-propanesultone of 5 wt % to 20 wt %, a nitriles compound of 3 wt % to 30 wt %, a water and acid removing additive of 0.005 wt % to 30 wt %, and at least one sodium salt. The second electrolyte contains PS of a relatively high concentration, and the high-concentration PS can effectively repair the SEI films and improve the high-temperature performance and cycle life of the sodium-ion rechargeable batteries. The nitriles can withstand high temperatures and inhibit generation of gas. The water and acid removing additive can remove the water and acid in the electrolytes, thereby reducing the amount of gas generated by the reaction between these impurities and sodium salts, effectively suppressing the generation of gas, and reducing the growth rate of internal resistance during long-term cycling process. In summary, the technical solutions provided by the embodiments of the present disclosure are conducive to achieving an effective balance among low interface impedance of SEI films, low generation of gas, and stability during long-term cycle in the sodium-ion rechargeable batteries.

In the illustration of the embodiments of the present disclosure, technical terms such as “first” and “second” are only used to distinguish different objects and shall not be understood as indicating or implying relative importance or implying the quantity, specific order, or primary and secondary relationship of the indicated technical features. In the illustration of the embodiments of the present disclosure, “a plurality of” refers to two or more, unless otherwise specified.

Referring to “embodiments” in the present disclosure means that specific features, structures, or characteristics described in conjunction with the embodiments may be included in at least one embodiment of the present disclosure. Referring to this phrase at various portions in the description does not necessarily relates to the same embodiment, nor an independent or alternative embodiment that is mutually exclusive with other embodiments. Those skilled in the art shall explicitly and implicitly understand that the embodiments described in the present disclosure can be combined with other embodiments.

In the illustration of the embodiments of the present disclosure, the term “and/or” is only used for describing the association relationships between associated objects, indicating that there can be three types of relationships. For example, A and/or B represents: the existence of A, the concurrent existence of A and B, and the existence of B. In addition, the character “/” in the present disclosure generally indicates that the associated objects are in an “or” relationship.

In the illustration of the embodiments of the present disclosure, the term “a plurality of” refers to two or more (including two). Similarly, “a plurality of groups” refers to two or more groups (including two groups), and “a plurality of pieces” refers to two or more pieces (including two pieces).

In the illustration of the embodiments of the present disclosure, when a component “includes” another component, other components are not excluded unless otherwise stated, and other components may be further included. In addition, when components such as layers, films, regions, or plates are referred to as being “on” another component, they may be “directly on” another component (i.e. there is no other components between them) or there may be other components present therebetween. In addition, when a component such as a layer, a film, a region, or a plate is “directly on” another component, or the component such as a layer, a film, a region, or a plate is at a surface of another component, it means that there are no other components between them.

The terms used in the illustration of various embodiments in the present disclosure are only intended to illustrate specific embodiments and are not intended to be limiting. As used in the illustration of various embodiments and the accompanying claims, “the component” is also intended to include the plural form, unless the context otherwise specifies. The component includes a layer, a film, a region, a plate, or the like.

Embodiments of the present disclosure will be described in detail below with reference to the accompanying drawings. Those skilled in the art shall understand that, in the embodiments of the present disclosure, many technical details are provided for the reader to better understand the embodiments of the present disclosure. However, even without these technical details and various modifications and variants based on the following embodiments, the technical solutions claimed in the present disclosure can be implemented.

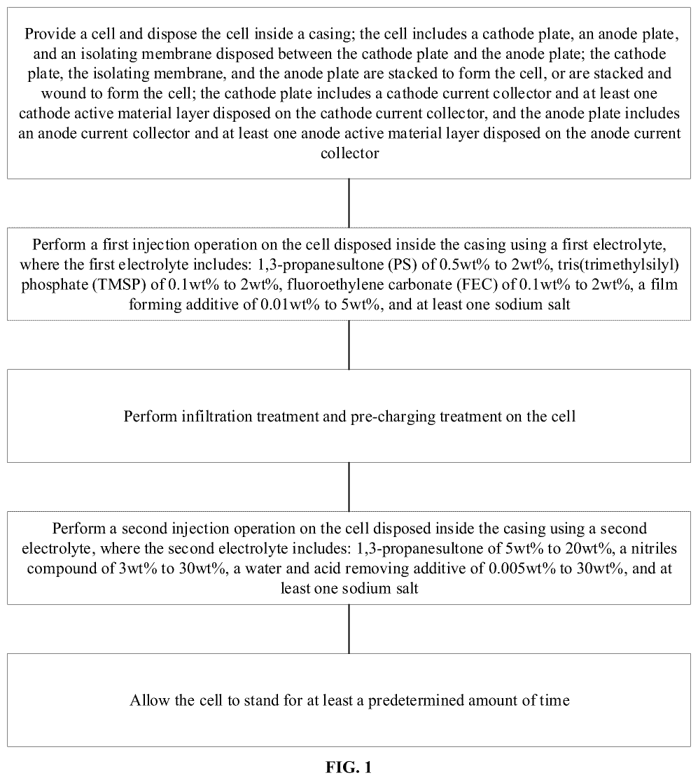

FIG. 1 is a flow chart of the method for manufacturing sodium-ion rechargeable batteries provided in some embodiments of the present disclosure.

It is noted that the sodium-ion rechargeable batteries referred to in the embodiments of the present disclosure belong to sodium-ion batteries.

Referring to FIG. 1, the method for manufacturing sodium-ion rechargeable batteries includes the following operations.

A cell is provided and disposed inside a casing. The cell includes a cathode plate, an anode plate, and an isolating membrane disposed between the cathode plate and the anode plate. The cathode plate, the isolating membrane, and the anode plate are stacked to form the cell, or the cathode plate, the isolating membrane, and the anode plate are stacked and wound to form the cell. The cathode plate includes a cathode current collector and at least one cathode active material layer disposed on the cathode current collector, and the anode plate includes an anode current collector and at least one anode active material layer disposed on the anode current collector.

The cell may have a stacked structure formed by stacking the anode plate, the isolating membrane, and the cathode plate in sequence, or have a wound structure formed by stacking the anode plate, the isolating membrane, and the cathode plate in sequence and then winding them.

The cathode plate includes a cathode current collector and at least one cathode active material layer that includes cathode active materials and is disposed on at least one surface of the cathode current collector. For example, the cathode current collector has two opposite surfaces perpendicular to a thickness direction of the cathode current collector, and two cathode active material layers are provided and disposed on the two opposite surfaces, respectively. Alternatively, the at least one cathode active material layer is disposed on one of the two opposite surfaces.

The cathode active material may include a layered oxide cathode material, a polyanionic cathode material, a Prussian blue (PB) cathode material, an organic cathode material, or a converted cathode material. In other words, the at least one cathode active material layer includes an oxide cathode material, a polyanionic cathode material, or PB cathode material.

The chemical formula of the layered oxide cathode material is NaₓM1O₂, M1 represents a transition metal element such as Fe, Mn, Ni, Co, and Cr, and 0<x≤1. For example, the layered oxide cathode material may be NaFeO₂, NaCrO₂, Na_{0.5}CoO₂, or NaNiO₂.

The general formula for the polyanionic cathode material is NaₓM2_{y}(XₐO_{b})_{z}Z_{w}, and this general formula is electrochemically neutral. M2 may a transition metal element selected from Ti, V, Cr, Mn, Fe, Co, Ni, Ca, Mg, Al, and Nb, X is selected from Si, S, P, As, B, Mo, W, and Ge, and Z is F or OH. For example, the polyanionic cathode material may be sodium phosphates, sodium sulfate salts, or sodium purosulfate salts. For example, the polyanionic cathode material may be sodium iron phosphate (NaFePO₄) or sodium ferric sulfate (Na₂Fe(SO₄)₂).

The general formula for the PB cathode material is AₓM1[M2(CN)₆]_{1-y}·V_{y}·nH₂O, 0≤x≤2, and 0≤y≤1. V represents a vacancy for [M2(CN)₆], and A represents an alkali metal ion such as a Na ion or a K ion. In a sodium-ion rechargeable battery, A is a Na ion. Each of M1 and M2 represents a respective transition metal ion, such as Mn, Fe, Co, Ni, Cu, Zn, or Cr. H₂O represents interstitial water (or, zeolitic water) and coordinated water.

For example, an exemplary PB cathode material may be NaₓMFe(CN)₆, M may be Mn, Co, Ni, Cu, Zn, or Cr. The PB cathode material includes Mn Fe—PB, Cr Fe—PB, Ni Fe—PB, Co Fe—PB, Cu Fe—PB, Zn Fe—PB, and the PB analogues obtained by doping other transition metal ions.

The at least one cathode active material layer may further include a conductive agent and a binder. The conductive agent is used to improve the conductivity of the at least one cathode active material layer, and the binder is used to firmly adhere the cathode active material to the cathode current collector.

In some embodiments, the conductive agent may be one or more of superconducting carbon, acetylene black, carbon black, Ketjen black, carbon dots, carbon nanotubes, graphene, and carbon nanofibers. The binder may be one or more of polymerized styrene butadiene rubber (SBR), water-based acrylic resin, carboxymethyl cellulose (CMC), polyvinylidene difluoride (PVDF), polytetrafluoroethylene (PTFE), ethylene-vinyl acetate copolymer (EVA), and polyvinyl alcohol (PVA).

The cathode current collector may be made of metal foils, carbon-coated metal foils, or porous metal plates. In some embodiments, the cathode current collector is made of aluminum foils.

In some embodiments, the cathode plate may be manufactured by: dispersing the cathode active materials, the conductive agent, and the binder in a solvent to form a cathode paste; coating the cathode paste on the surface(s) of the cathode current collector; and performing drying and cold pressing treatment, thereby obtaining the cathode plate.

The anode plate includes an anode current collector and at least one anode active material layer that includes anode active materials and is disposed on at least one surface of the anode current collector. For example, the anode current collector has two opposite surfaces perpendicular to a thickness direction of the anode current collector, and two anode active material layers are provided and disposed on the two opposite surfaces, respectively. Alternatively, the at least one anode active material layer is disposed on one of the two opposite surfaces.

The anode active material may be a metal compound, a carbon-based material, an alloy material, or a non-metallic simple substance. In other words, the materials of the at least one anode active material layer include a metal compound, a carbon-based material, an alloy material, or a non-metallic simple substance.

The carbon-based material may be hard carbon, soft carbon, carbon nanotubes, expanded graphite, or graphene. The hard carbon and soft carbon have excellent electrochemical performance and cycling stability. The carbon nanotubes have high conductivity and a large specific surface area, which are conducive to improvement of performance of the batteries. The expanded graphite and graphene are widely used in anode plates due to their excellent conductivity and mechanical properties.

The metal compound may be lithium titanate, which can provide good cycle life and high safety.

The at least one anode active material layer may further include a conductive agent and a binder. The conductive agent is used to improve the conductivity of the at least one anode active material layer, and the binder is used to firmly adhere the anode active material to the anode current collector.

The anode current collector may be made of metal foils, carbon-coated metal foils, or porous metal plates. In some embodiments, the anode current collector is made of copper foils. In some other embodiments, the anode current collector may also be made of aluminum foils.

In some embodiments, the anode plate may be manufactured by: dispersing the anode active materials, the conductive agent, and the binder in a solvent to form an anode paste; coating the anode paste on the surface(s) of the anode current collector; and performing drying and cold pressing treatment, thereby obtaining the anode plate.

The isolating membrane may be made of one or more materials, including polypropylene (PP), polyethylene (PE), ceramic coating, and non-woven fabrics. The porous isolating membranes made of PP and PE have good mechanical strength and chemical stability. The isolating membranes made of ceramic coating are coated with ceramic material on the basis of the isolating membranes made of PP or PE, thereby improving the high temperature resistance and safety of the isolating membranes. The isolating membranes made of non-woven fabrics are formed by polymer fibers and has excellent electrolyte wettability and ion conductivity.

In addition, the isolating membrane may be a single-layer thin film or a multi-layer thin film.

In some embodiments, after preparing the cathode plate, the anode plate, and the isolating membrane, they are stacked and wound to form the cell. In some other embodiments, the cell also may have the above-mentioned stacked structure.

In some embodiments, the sodium-ion rechargeable battery is composed of pouch cells. Accordingly, the casing is flexible. For example, the casing may be made of aluminum-plastic films.

In some embodiments, the manufactured sodium-ion rechargeable battery may have a capacity of 3 Ah, where Ah represents ampere-hour.

It is noted that the embodiments of the present disclosure do not limit the type of the sodium-ion rechargeable batteries. In some other embodiments, the sodium-ion rechargeable batteries may also be composed of prismatic and cylindrical cells, and may be square sodium-ion batteries or cylindrical sodium-ion batteries. Correspondingly, the casing is made of metal or other hard materials.

In the following, a sodium-ion rechargeable battery composed of pouch cells and having a casing made of aluminum-plastic films is taken as an example to illustrate in detail.

The operation of disposing the cell inside the casing includes: after preparing the aforementioned cell, wrapping the cell completely with aluminum-plastic films; sealing the aluminum-plastic films, and leaving an opening on the aluminum-plastic films as an electrolyte injection port for the subsequent first injection operation.

Referring to FIG. 1, the first injection operation is performed on the cell disposed inside the casing using the first electrolyte. The first electrolyte includes, in mass percentage, 1,3-propanesultone (PS) of 0.5 wt % to 2 wt %, tris(trimethylsilyl) phosphate (TMSP) of 0.1 wt % to 2 wt %, fluoroethylene carbonate (FEC) of 0.1 wt % to 2 wt %, a film forming additive of 0.01 wt % to 5 wt %, and at least one sodium salt.

The electrolyte injected in the first injection operation is used to form stable SEI films, which have the characteristics of low impedance, good density, and uniformity.

The first electrolyte includes, in mass percentage, the at least one sodium salt of 5 wt % to 15 wt %.

In addition to the PS, FEC, TMSP, at least one sodium salt, and the film forming additive, the first electrolyte further includes non-aqueous organic solvents.

In some embodiments, the first electrolyte may include the PS of 0.5 wt %, 0.6 wt % 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, or 2.0 wt %.

In some embodiments, the first electrolyte may include the TMSP of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, or 2.0 wt %.

In some embodiments, the first electrolyte may include the FEC of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, or 2.0 wt %.

In some embodiments, the first electrolyte may include the at least one sodium salt of 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12. wt %, 13 wt %, 13.5 wt %, 14 wt %, 14.5 wt %, or 15 wt %.

The at least one sodium salt may be one or more of sodium hexafluorophosphate (NaPF₆), sodium perchlorate (NaClO₄), sodium tetrafluoroborate (NaBF₄), sodium hexafluoroarsenate (NaAsF₆), sodium tetrachloroaluminate (NaAlCl₄), sodium trifluoroacetate (NaTFA), sodium tetraphenylborate (NaBPh₄), sodium difluorophosphate (NaDFP), sodium bis(oxalato)borate (NaBOB), sodium difluorooxalatoborate (NaDFOB), sodium trifluoromethanesulfonate (NaOTF), sodium bis(fluorosulfonyl)imide (NaFSI), and sodium bis(trifluoromethanesulfonyl)imide (NaTf₂N).

In some embodiments, the first electrolyte may include the film forming additive of 0.01 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.5 wt %, 2 wt %, 2.5 wt %, 3 wt %, 3.5 wt %, 4 wt %, 4.5 wt %, or 5 wt %.

The film forming additive may include, but is not limited to, the combination of one or more of the following: NaDFP, methane disulfonate (MMDS), ethylene sulfate (DTD), Tris(trimethylsilyl)borate (TMSB), 2-propyne-1-yl 1H-imidazole-1-carboxylate, triallyl isocyanurate (TAIC), toluene diisocyanate (TDI), 2-phenyl-1-yl 1H-imidazole-1-sulfonic esters, hexamethylene diisocyanate (HDI), sodium difluorooxalatophosphate (NaDFOP), 2-fluoropyridine (2-FP), NaBOB, NaDFOB, allyl methanesulfonate (AMS), and disodium 1,3-propanedisulfonate.

In some embodiments, the first electrolyte may include, in mass percentage, the film forming additive of 0.5 wt % to 3 wt %. The selection and dosage of the film forming additive aim to optimize the overall performance of the sodium-ion rechargeable batteries, especially to improve the quality of SEI films, thereby improving the cycling stability and capacity retention of the sodium-ion rechargeable batteries.

The non-aqueous organic solvents may include at least one of: ethylene carbonate (EC), propylene carbonate (PC), butylene carbonate (BC), dimethyl carbonate (DMC), methyl ethyl carbonate (EMC), diethyl carbonate (DEC), dipropyl carbonate (DPC), methyl propyl carbonate (MPC), ethyl propyl carbonate (EPC), 1,4-Butyrolactone (GBL), methyl propionate (MP), methyl butyrate (MB), ethyl acetate (EA), ethyl propionate (EP), or propyl propionate (PP).

In some embodiments, the non-aqueous organic solvents may be selected from a mixture of two or more of DMC, DEC, EMC, PC, and EC mixed in any proportion.

In addition, cyclic esters, linear esters, ethers, or sulfones may also be added into the first electrolyte to optimize the performance and stability of the first electrolyte.

Referring to FIG. 1, after injection of the first electrolyte, the infiltration treatment and the pre-charging treatment are performed in sequence.

FEC has a standard decomposition potential lower than that of PS, therefore FEC has more advantages under low-temperature and high-power discharge conditions, and stable SEI films can be formed first. The standard decomposition potential of PS is higher than that of TMSP, therefore PS can provide moderate interface protection for the SEI films, thereby improving the density and stability of the SEI films, and being conducive to improvement of the performance and life of the sodium-ion rechargeable batteries in high-temperature storage and cycling. TMSP, as a typical film forming additive for cathodes, is mainly used to protect the cathode and form a stable cathode protection layer (namely cathode electrolyte interphase (CEI) films) with low impedance, which is conducive to improvement of performance in recycle.

After the infiltration treatment and the pre-charging treatment, FEC and PS work together to generate stable SEI films, and due to the relatively low concentration of PS in the first electrolyte, the problem of a sharp increase in impedance of SEI films caused by using a large amount of PS can be prevented, thereby forming SEI films with relatively low internal resistance (i.e. impedance).

The infiltration treatment may include a first infiltration stage and a second infiltration stage performed in sequence, a temperature for the first infiltration stage is greater than a temperature for the second infiltration stage, and a duration of the first infiltration stage is less than a duration of the second infiltration stage

In some embodiments, the temperature for the first infiltration stage may range from 40° C. to 50° C., such as 42° C., 44° C. 45° C., 47° C., or 49° C. The duration of the first infiltration stage may range from 10 h to 15 h, such as 11 h, 12 h 13 h, or 14 h. The temperature for the second infiltration stage may range from 15° C. to 25° C., such as 16° C., 18° C., 20° C., 21° C., or 24° C. The duration of the second infiltration stage may range from 20 h to 30 h, such as 22 h, 24 h, 26 h, or 28 h.

With the above-mentioned process of infiltration treatment, the cell can be better wetted by the first electrolyte, thereby allowing the cell to effectively and fully contact with the first electrolyte, which allows the first electrolyte to better penetrate into the pores of the cathode active material layer and the anode active material layer, especially into the micro gaps between the active material particles of the cathode active material layer and the anode active material layer. In this way, the contact area and reaction activity between the first electrolyte and the cathode plate or the anode plate can be increased, which is conducive to further promoting the formation of the stable SEI films on the surface(s) of the anode plate.

The pre-charging treatment is used as a formation treatment. In other words, before the second injection operation, the SEI films and the CEI films have been formed in the sodium-ion rechargeable battery.

Before the pre-charging treatment, the injection opening for electrolytes defined on the casing may be sealed, and a spatial margin is left at the sealed section. During the pre-charging treatment, the reaction between the composition in the first electrolyte results in by-products such as gas, which will escape to the spatial margin at the sealed section, causing that a gas bag filled with gas is formed at the sealed section.

The pre-charging treatment may include: performing constant-current charging at a charging rate ranged from 0.04 C to 0.06 C; and ending the pre-charging treatment at a voltage of 3.4V. The charging rate is a measure of the speed of charging, which refers to the current value required for a battery to charge to its rated capacity within a specified duration. Generally, the charging rate is denoted by C, and the charging rate C is equal to the quotient of the charging current (A) divided by the rated capacity (Ah) of the battery. The higher the charging rate, the faster the battery is charged and discharged.

In some embodiments, the constant-current charging may be performed at a charging rate of 0.045 C, 0.05 C, or 0.055 C.

The method may further include, after the pre-charging treatment, allowing the cell to stand for 10 h to 14 h under a third temperature, and the third temperature ranges from 40° C. to 50° C. For example, the third temperature may be 42° C., 44° C., 45° C., 47° C., or 49° C., and the standing duration may be 11 h, 12 h, or 13 h. With the standing, the cell can be discharged to a certain extent.

During the pre-charging treatment, gas extraction from the casing may be performed, in order to remove the by-product such as gas generated during the pre-charging treatment, and to fully discharge the gas and prevent the gas from leaving inside the casing, thereby further reducing the residual gas content inside the casing.

In some embodiments, as illustrated above, before the pre-charging treatment, the injection opening for electrolytes defined on the casing may be sealed, and a spatial margin is left at the sealed section. During the pre-charging treatment, the reaction between the composition in the first electrolyte results in by-products such as gas, which will escape to the spatial margin at the sealed section, causing that a gas bag filled with gas is formed at the sealed section. Before the second injection operation, the casing may be sealed again to completely separate the formed gas bag from the cell and all electrolyte. After sealing again, the gas bag is removed from the casing, which is referred to as the gas extraction.

In some other embodiments, the gas extraction may include: before the pre-charging treatment, the injection opening for electrolytes defined on the casing may be sealed, and additional exhaust pipes and sucking pumps are provided, with the exhaust pipes entering the interior of the casing via the sealed section. Under the drive of the sucking pumps, the exhaust pipes extract gas from the casing to exhaust the gas from the interior of the casing.

Referring to FIG. 1, the second injection operation is performed on the cell disposed inside the casing using the second electrolyte. The second electrolyte includes, in mass percentage, 1,3-propanesultone of 5 wt % to 20 wt %, a nitriles compound of 3 wt % to 30 wt %, a water and acid removing additive of 0.005 wt % to 30 wt %, and at least one sodium salt.

Before the preceding pre-charging treatment, the casing is sealed. Thus, before performing the second injection operation, the casing is opened to form the injection opening for the electrolyte used in the second injection operation again.

The concentration of PS in the second electrolyte provided in the second injection operation is greater than that of PS in the first electrolyte provided in the first injection operation. The second electrolyte is used for further repair and stabilization of SEI films and CEI films, for example is used to provide PS and sodium salts required for long-term cycling process. PS can repair the SEI films during long-term cycling process, and the sodium salts provided in the second electrolyte can serve as a supplement to the sodium salts in the electrolytes.

When the amount of the first electrolyte provided in the first injection operation is insufficient, the cell may be not fully infiltrated, and it is prone to cause the precipitation of sodium ions after the pre-charging treatment (i.e. formation). When the amount of the second electrolyte provided in the second injection operation is excessive, the second electrolyte contains relatively large amount of additive, which may lead to uneven distribution of the concentration of the additive in the casing.

Therefore, a ratio of mass of the first electrolyte to a sum of the mass of the first electrolyte and mass of the second electrolyte ranges from 65% to 90%, for example 70 wt %, 75 wt %, 80 wt %, 82 wt %, 85 wt %, or 88 wt %. In this way, the optimal performance of the cell can be ensured. In the first injection operation, the cell can be fully infiltrated without causing the precipitation of sodium ions, and after the second injection operation, the distribution of the concentration of additives inside the casing is uniform.

In some embodiments, a ratio of the mass of the first electrolyte to the mass of the second electrolyte may be 85:15.

The nitriles compound in the second electrolyte can withstand high temperatures and inhibit generation of gas. The high-concentration PS can effectively repair the formed SEI films and improve the high-temperature performance and cycle life of the sodium-ion rechargeable batteries. The water and acid removing additive can remove the water and acid in the electrolytes, thereby reducing the amount of gas generated by the reaction between these impurities and sodium salts, and effectively suppressing the generation of gas.

The mass of the 1,3-propanesultone in the second electrolyte and mass of the 1,3-propanesultone in the first electrolyte may meet: 40%×M≤m1≤50%×M, 50%×M≤m2≤60%×M, and M=m1+m2. Herein m1 refers to the mass of the 1,3-propanesultone in the first electrolyte, and m2 refers to the mass of the 1,3-propanesultone in the second electrolyte. In this way, the total amount of 1,3-propanesultone in the electrolyte after the two injection operations is moderate, the amount of 1,3-propanesultone provided in the first injection operation can significantly improve the density and stability of the SEI films, and the amount of 1,3-propanesultone provided in the second injection operation can ensure effective repair of the SEI films during long-term cycling process.

In some embodiments, the mass of 1,3-propanesultone in the first electrolyte accounts for 42%, 44%, 45%, 47%, or 49% of a total mass. Correspondingly, the mass of 1,3-propanesultone in the second electrolyte accounts for 58%, 56%, 55%, 53%, or 51% of the total mass. The total mass refers to the sum of the mass of 1,3-propanesultone in the first electrolyte and the mass of 1,3-propanesultone in the second electrolyte.

The second electrolyte includes, in mass percentage, the at least one sodium salt of 5 wt % to 15 wt %.

In addition, the second electrolyte further includes non-aqueous organic solvents. The material of the at least one sodium salt in the first electrolyte may be the same as the material of the at least one sodium salt in the second electrolyte, and the material of the non-aqueous organic solvents in the first electrolyte may be the same as the material of the non-aqueous organic solvents in the second electrolyte.

In some embodiments, the second electrolyte may include the 1,3-propanesultone of 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %.

In some embodiments, the second electrolyte may include the at least one sodium salt of 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt % or 15 wt %.

In some embodiments, the second electrolyte may include the water and acid removing additive of 0.005 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.5 wt %, 2 wt %, 2.5 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt % or 30 wt %.

In some embodiments, the second electrolyte may include the nitriles compound of 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt %.

In some embodiments, the second electrolyte includes the nitriles compound of 10 wt % to 25 wt % and the water and acid removing additive of 5 wt % to 10 wt %. The mass percentage of the nitriles compound and of the water and acid removing additive within these ranges is conducive to further reducing the initial internal resistance of the sodium-ion rechargeable batteries, and to further reducing the growth rate of internal resistance and gas generation rate during long-term cycling process, thereby further improving the performance in long-term cycling of the sodium-ion rechargeable batteries.

For materials of the at least one sodium salt and the non-aqueous organic solvents, reference may be made to the corresponding description of the first electrolyte hereinbefore, which will not be elaborated here.

The nitriles compound includes nitrile substances having C≡N bonds. For example, the nitriles compound includes a dinitriles compound, a trinitriles compound, an unsaturated nitriles compound, an aromatic-ring-containing nitriles compound, an alkoxynitriles compound, a sulfonyl-containing nitriles compound, or a trimethylsilyl-containing nitriles compound. These nitriles compounds, with their unique chemical structures and properties, can play important roles in the electrolyte of the sodium-ion rechargeable batteries, thereby improving high-temperature storage and cycling performance, reducing gas generation, and extending the life of the sodium-ion rechargeable batteries.

The dinitriles compound includes succinonitrile (SN), adiponitrile (ADN), glutaronitrile (GN), suberonitrile (SNB), or sebaconitrile (SCN). The trinitriles compound includes 1,3,6-hexanetricarbonitrile (HTCN) or 1,3,5-pentanetetricarbonitrile (PTN). The unsaturated nitriles compound includes acrylonitrile (AN), crotononitrile (CN), trans-butenedinitrile (TBN), or 1,4-dicyanobutene (DCB). The aromatic-ring-containing nitriles compound includes 4-fluorobenzonitrile (4-FBN), 4-methylbenzonitrile (4-MBN), or tricyanobenzene (TCB). The alkoxynitriles compound includes 1,2-di(cyanoethoxy)ethane (DENE), or 1,2,3-tris(cyanoethoxy)propane (TCEP). The sulfonyl-containing nitriles compound includes sulfolane dinitrile (SDPN). The trimethylsilyl-containing nitriles compound includes 3-(trimethylsilyloxy)propionitrile (TMSOPN).

The water and acid removing additive may include a carbodiimide compound, a silazane compound, an amine compound, methanesulfonyl chloride (MSC), tetrahydrofuran (THF), or trifluoroacetic anhydride (TFAA).

The carbodiimide compound includes dicyclohexylcarbodiimide (DCC) or diisopropylcarbodiimide (DIC). The silazane compound includes hexamethyldisilazane (HMDS), heptamethyldisilazane (H7DMS), or trimethylchlorosilane (TMCS). The amine compound includes triethylamine (TEA) or diethylamine (DEA).

The second electrolyte may further include, in mass percentage, a functional additive of 0 wt % to 2 wt %, and the functional additive includes the film forming additive or a gas inhibiting additive. For example, the second electrolyte may include the functional additive of 1.5 wt %, 1 wt %, 0.8 wt %, or 0.4 wt %.

The functional additive includes one or more of: NaDFOB, NaDFP, NaBOB, MMDS, DTD, triallyl phosphate, tripropargyl phosphate, prop-1-ene-1,3-sultone, fluorobenzene, trifluoroethoxy ethylene carbonate, citraconic anhydride, di-Fluoro ethylene carbonate, succinic anhydride, TMSP, glycol sulfite, and HDI.

It shall be understood that the selection and dosage of the functional additive in the embodiments of the present disclosure may be flexibly adjusted as needed.

The nitriles compound, due to the high bond energy and good oxidation resistance of the cyano groups, can coordinate with high-valence transition metal ions on the surfaces of the cathode plate under high-temperature conditions to form stable complexes, thereby reducing the catalytic decomposition of the electrolyte by the electrodes, suppressing side reactions, and reducing the possibility of generation of gas. The nitriles compound can also form polymer films containing cyano groups on the surfaces of the anode plate, thereby further improving the cycling stability and high-temperature performance of the sodium-ion rechargeable batteries.

The second electrolyte contains PS of relatively high concentration, and the high-concentration PS can effectively repair the formed SEI films and improve the high-temperature performance and cycle life of the sodium-ion rechargeable batteries.

The water and acid removing additive, such as DCC and DIC, reacts with water and acidic substances to generate amides and neutral by-products, in order to reduce the amount of gas generated by the reaction between these impurities and sodium salts, thereby effectively suppressing generation of gas and improving the stability of the sodium-ion rechargeable batteries during high-temperature storage and cycling.

The two injection operations use electrolytes with different formulations, in other words, the first injection operation is performed using the first electrolyte first, and then the second injection operation is performed using the second electrolyte. This manufacturing method can effectively balance the low impedance, long cycling life, and adaptability to high and low temperature of the sodium-ion batteries, and is compatible with existing manufacturing processes, thereby achieving comprehensive improvement in the electrochemical performance of the sodium-ion batteries. The adaptability to high and low temperatures mainly includes the improved generation of gas under high or low temperature conditions, and relatively low impedance.

The first electrolyte contains relatively low content of 1,3-propanesultone of 0.5 wt % to 2 wt %, which, together with TMSP, FEC, and the film forming additive, forms dense and effective SEI films and CEI films with low impedance during the pre-charging treatment, thereby preventing the problem of incomplete reaction and high impedance caused by adding a large amount of additives once, and overcoming the defect of uncontrolled generation sequence due to different film-forming potentials of various additives. Therefore, relatively ideal SEI films/CEI films can be selectively designed.

The second electrolyte contains nitrile solvents and effective functional additives (i.e., the water and acid removing additive) targeted at moisture, in order to synergistically solve the problem of long-term generation of gas. In the case that effective SEI films/CEI films have been generated, the second electrolyte generally exists in the sodium-ion rechargeable battery in a free form. By adding the nitrile solvents and the effective functional additive targeted at moisture, the problem of long-term generation of gas of the sodium-ion rechargeable battery can be addressed in a targeted way, and the 1,3-propanesultone in the second electrolyte can also repair the SEI films in a targeted way, thereby improving the long-term cycling performance of the sodium-ion rechargeable batteries.

Moreover, the nitriles compound, due to the high bond energy and good oxidation resistance of the cyano groups, can coordinate with high-valence transition metal ions on the surfaces of the cathode plate under high-temperature conditions to form stable complexes, thereby reducing the catalytic decomposition of the electrolyte by the electrodes, suppressing side reactions, and reducing the possibility of generation of gas. The nitriles compound can also form polymer films containing cyano groups on the surfaces of the anode plate, thereby further improving the cycling stability and high-temperature performance of the sodium-ion rechargeable batteries.

The second electrolyte provides PS of relatively high concentration. The high-concentration PS can effectively repair the SEI films formed after the first injection operation and improve the high-temperature performance and cycle life of the sodium-ion rechargeable batteries.

The water and acid removing additive, such as DCC and DIC, reacts with water and acidic substances to generate amides and neutral by-products, in order to reduce the amount of gas generated by the reaction between these impurities and sodium salts (such as sodium hexafluorophosphate), thereby effectively suppressing generation of gas and improving the stability of the sodium-ion rechargeable batteries during high-temperature storage and cycling.

Referring to FIG. 1, after the second injection operation, the cell is allowed to stand.

After injection of the second electrolyte, the injection opening for electrolytes defined on the casing is sealed.

In some embodiments, the cell is allowed to stand for 10 h to 15 h under a temperature ranged from 40° C. to 50° C. For example, the temperature may be 42° C., 45° C., or 48° C.

After the standing process, capacity sorting may be performed. The capacity of the sodium-ion rechargeable batteries manufactured on a same production line may vary, and the capacity sorting refers to that the qualified batteries are screened using capacity testing.

From the above analysis, it can be seen that in the present disclosure, two separated injection operations are adopted, and the overall stability of the SEI films and the performance of the sodium-ion rechargeable batteries can be significantly improved by utilizing the advantages of FEC, PS, TMSP, nitrile substances, and water and acid removing additive. The FEC provided in the first injection operation is used to form initial SEI films, ensuring low-temperature performance and energy efficiency performance. The PS provided in the first injection operation is used to improve the density and stability of the SEI films, especially to provide additional protection under high-temperature conditions. The TMSP provided in the first injection operation forms a stable protective layer on the cathode plate, to reduce impedance and improve cycling performance.

The nitrile substances and the water and acid removing additive provided in the second injection operation work together, thereby effectively suppressing the generation of gas in the sodium-ion rechargeable batteries, and improving high-temperature cycling performance. The PS and the at least one sodium salt provided in the second injection operation are used to effectively repair the formed SEI films during long-term cycling, thereby improving the high-temperature performance and cycle life of the cell.

That is to say, the embodiments of the present disclosure not only improve the initial performance of the sodium-ion rechargeable batteries, but also maintain excellent cycling stability during long-term use. The two separated injection operations successfully achieve an effective balance among low interface impedance, low generation of gas, and stability during long-term cycle of the sodium-ion rechargeable batteries. This synergistic effect not only improves the initial performance of the batteries by optimizing the function and application timing of each additive, but also maintains excellent cycling stability during long-term use.

During the pre-charging treatment after injecting the first electrolyte, gas extraction may be performed to fully discharge the gases generated during the formation (i.e. pre-charging) process, thereby preventing the gases from remaining in the electrolyte, and further addressing the common problems of high generation of gas and poor cycling performance in the sodium-ion batteries. In addition, the extraction treatment can also discharge the by-products generated by the oxidation-reduction reaction in the electrolyte, thereby further reducing the interface impedance of the SEI films. The oxidation-reduction reaction occurs during the pre-charging treatment.

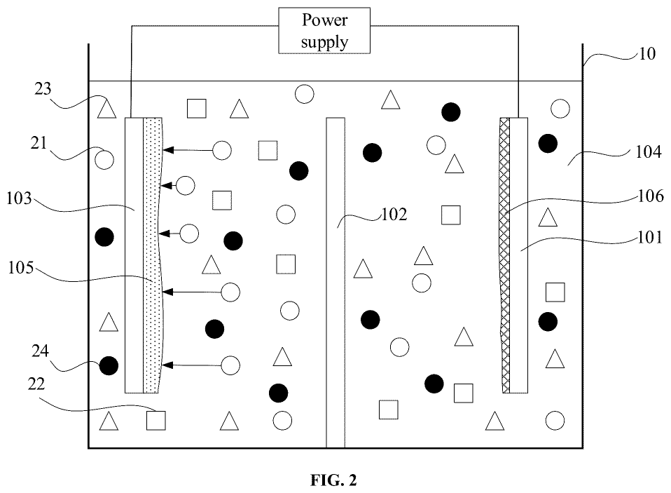

FIG. 2 is a schematic diagram of a structure of a cell of a sodium-ion rechargeable battery provided in some embodiments of the present disclosure. In FIG. 2, the second injection operation has been performed on the cell. It is noted that the power supply shown in FIG. 2 is provided for pre-charging before the second injection operation, and FIG. 2 is not a schematic diagram of the actual structure of a cell of a sodium-ion rechargeable battery. FIG. 2 shows the casing 10, the cathode plate 101, the isolating membrane 102, the anode plate 103, and the electrolyte 104 which is a mixture of the first electrolyte and the second electrolyte. In addition, in FIG. 2, a single cell is taken as an example, in order to depict the structure of each cell clearly. In practice, a sodium-ion rechargeable battery may include a plurality of cells as shown in FIG. 2, for example 2, 3,4, 5, 6 cells, or the like.

In FIG. 2, the white-filled circular box 21 represents the PS provided in the second injection operation, the square box 22 represents the at least one sodium salt provided in the second injection operation, the triangular box 23 represents the nitriles compound provided in the second injection operation, and the black-filled circular dots 24 represent the water and acid removing additive provided in the second injection operation.

It is noted that the content and location of each substance (such as PS, sodium salts, nitriles compound, and water and acid removing additive) in FIG. 2 are only illustrative and do not constitute limitations in the present disclosure. In addition, the shapes of the SEI film 105 and the CEI film 106 in FIG. 2 are only illustrative and do not constitute limitations in the present disclosure.

Referring to FIG. 2, after the first injection operation, a power supply is used for pre-charging. During the pre-charging treatment, the anode plate 103 is polarized, and the composition of the first electrolyte reacts to form new chemical products. Then, some of the chemical products precipitate on the surface(s) of the anode plate 103 to form the SEI film 105, and some chemical products precipitate on the surface(s) of the cathode plate 101 to form the CEI film 106. Specifically, FEC in the first electrolyte reacts prior to PS to form an initial SEI film on the surface(s) of the anode plate 103. Then, PS in the first electrolyte reacts to generate chemical products, which form the SEI film 105 on the basis of the initial SEI film, thereby improving the density and stability of the SEI film 105. In other words, the formed SEI film 105 covers on the at least one anode active material layer of the anode plate 103, and the formed CEI film 106 covers on the at least one cathode active material layer of the cathode plate 101.

Referring to FIG. 2, after the second injection operation, the electrolyte 104 contains PS, sodium salts, the nitriles compound, and the water and acid removing additive. During long-term cycling, PS can undergo reduction and decomposition to form new chemical products, which can repair the SEI film 105, for example can continue to deposit and form films on the surface of the SEI film 105. FIG. 2 illustrates, with arrow lines, the path of repairing the SEI film 105 by the chemical products corresponding to some PS.

In addition, the sodium ions in the at least one sodium salt provided in the second injection operation can be used to supplement the amount of sodium ions that may be embedded into and separated out of the cathode plate 101 and the anode plate 103 in the electrolyte 104 during long-term cycling, thereby preventing the problem of reduced amount of free sodium ions due to the inability of some sodium ions to separate out of the cathode plate 101 or the anode plate 103 during long-term cycling process. The functions of the nitriles compound and the water and acid removing additive may be referred to in the previous illustration, and will not be repeated here.

Moreover, referring to FIG. 2, the working principle of the sodium-ion rechargeable batteries is as follows: during the charging of the sodium-ion rechargeable batteries, the sodium ions in the cathode plate 101 are separated out of the cathode plate 101. The separated sodium ions are embedded, under the action of an electric field, into the anode plate 103 through the isolating membrane 102 in the electrolyte 104, causing the cathode plate 101 to be in a high-potential and low-sodium state, and causing the anode plate 103 to be in a low-potential and rich-sodium state.

The discharge process is opposite to the charging process. Sodium ions are separated out of the anode plate 103, pass through the isolating membrane 102 and the electrolyte 104, and are re-embedded into the cathode plate 101, thereby restoring the cathode plate 101 to a sodium-rich state. In order to maintain charge balance, an equal number of electrons are transferred via an external circuit during the charging and discharging process, respectively, and migrate, together with sodium ions, between the cathode plate 101 and the anode plate 103, thereby causing continuous oxidation reactions or reduction reactions of the cathode plate 101 and the anode plate 103. One of the cathode plate 101 and the anode plate 103 that loses electrons undergoes reduction reactions, and the other one that receives electrons undergoes oxidation reactions.

For ease of understanding, the following embodiments provide a more specific description of the present disclosure. These embodiments are only for illustrative purposes, as various modifications and changes within the scope of the present disclosure are apparent to those skilled in the art. Unless otherwise stated, all portions, percentages, and ratios referred to in the following embodiments are based on weight.

TABLE 1

| Serial | | | | | | | | | | | | | |
|---|---|---|---|---|---|---|---|---|---|---|---|---|---|
| number | | | | | | | | | | | | | |
| of | | | | | | | | | | | | | |
| bat- | Elec- | | | | | | | | | | | | |
| teries | trolyte | EC | PC | DEC | EMC | NaPF₆ | PS | TMSP | FEC | DENE | HTCN | DCC | DIC |
| D1 | First | 15 | 15 | 30 | 40 | 12.5 | 3.5 | | | | | | |
| | time | | | | | | | | | | | | |
| | Second | 15 | 15 | 30 | 40 | 12.5 | 3.5 | | | | | | |
| | time | | | | | | | | | | | | |
| D2 | First | 15 | 15 | 30 | 40 | 12.5 | 1.76 | | | | | | |
| | time | | | | | | | | | | | | |
| | Second | 15 | 15 | 30 | 40 | 12.5 | 13.33 | | | | | | |
| | time | | | | | | | | | | | | |
| D3 | First | 15 | 15 | 30 | 40 | 12.5 | 1.18 | 0.59 | | | | | |
| | time | | | | | | | | | | | | |
| | Second | 15 | 15 | 30 | 40 | 12.5 | 13.33 | | | | | | |
| | time | | | | | | | | | | | | |
| D4 | First | 15 | 15 | 30 | 40 | 12.5 | 1.18 | | 0.59 | | | | |
| | time | | | | | | | | | | | | |
| | Second | 15 | 15 | 30 | 40 | 12.5 | 13.33 | | | | | | |
| | time | | | | | | | | | | | | |
| D5 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | | | | |
| | time | | | | | | | | | | | | |
| D6 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | 3.33 | | | |
| | time | | | | | | | | | | | | |
| D7 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | | 3.33 | | |
| | time | | | | | | | | | | | | |
| E1 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | 3.33 | | 0.07 | |
| | time | | | | | | | | | | | | |
| E2 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | 3.33 | | | 0.07 |
| | time | | | | | | | | | | | | |
| E3 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | | 3.33 | 0.07 | |
| | time | | | | | | | | | | | | |
| E4 | First | 15 | 15 | 30 | 40 | 12.5 | 0.59 | 0.59 | 0.59 | | | | |
| | time | | | | | | | | | | | | |
| | Second | 15 | 15 | 30 | 40 | 12.5 | 13.33 | | | | 3.33 | | 0.07 |
| | time | | | | | | | | | | | | |

Table 1 shows the formulations of the first electrolyte and the second electrolyte used in the embodiments and the comparative examples of the present application. The non-aqueous organic solvents are EC, PC, DEC, and EMC, the sodium salt is NaPF₆, the nitriles compound is DENE or HTCN, the water and acid removing additive is DCC or DIC. TMSP refers to tris(trimethylsilyl) phosphate, PS refers to 1,3-propanesultone, FEC refers to fluoroethylene carbonate. In Table 1, the first time refers to the formulation of the first electrolyte used in the first injection operation, and the second time refers to the formulation of the second electrolyte used in the second injection operation.

Referring to Table 1, 7 comparative examples are provided, namely Comparative Example 1 to Comparative Example 7, and the serial numbers of the batteries manufactured using Comparative Example 1 to Comparative Example 7 are denoted by D1 to D7, respectively. Four experimental examples are provided, namely Experimental Examples 1 to 4, and the serial numbers of the batteries manufactured using Experimental Examples 1 to 4 are denoted by E1 to E4, respectively.

The formulations of the first electrolyte and second electrolyte used in Comparative Example 1 are the same, and the formulations of the first electrolyte and second electrolyte in the remaining comparative examples and in the experimental examples are different from each other. It is noted that all formulations of the electrolytes in Table 1 are comprehensive formulations, and the actual ratios of the additives in the electrolytes are calculated as follows: the non-aqueous organic solvents use the solvent mass percentage, and the sodium salts and the additives use the mass percentages of the overall formulations (i.e. the first electrolyte or the second electrolyte). That is, in practice, the amount of the non-aqueous organic solvents is calculated by: after subtracting the mass of the sodium salts and the mass of the additives from a mass of an electrolyte, multiply the difference by the solvent mass percentage of the non-aqueous organic solvents. When the non-aqueous organic solvents in the first electrolyte are calculated, the electrolyte refers to the first electrolyte; and when the non-aqueous organic solvents in the second electrolyte are calculated, the electrolyte refers to the second electrolyte. In addition, the additives refer to the composition other than the sodium salts and the non-aqueous organic solvents. In Table 1, the non-aqueous organic solvents are composed of EC, PC, DEC, and EMC.

Taking the first electrolyte of 100 g as an example, the calculation method for the mass of EC in the first electrolyte in Comparative Example 1 is: (100 g−mass of sodium salts−mass of additive)×15%, where the additive is PS, and the mass of PS is 3.5%×100=3.5 g, the mass of the sodium salts is 12.5%×100=12.5 g, and the mass of EC in Comparative Example 1 is (100−3.5−12.5)×15%=12.6 g. The calculation methods for the composition used in each comparative example and each experimental example will not be elaborated here.

The method for manufacturing sodium-ion rechargeable batteries corresponding to each comparative example and each experimental example includes the following operations:
I. manufacturing the cathode plate

The cathode active material NaNi_{1/3}Fe_{1/3}Mn_{1/3}O₂, conductive agent Super-P, conductive agent CNT, and adhesive PVDF are dissolved in N-methylpyrrolidone in a ratio of 95.5:2.0:0.5:2.0 to obtain a cathode paste, which is then evenly coated on an aluminum foil. The operations of drying, cold pressing, trimming, slicing, and slitting are performed, then tabs are welded to obtain a cathode plate.
II. manufacturing the anode plate

Hard carbon, as the anode active material, conductive agent Super-P, thickener CMC, and adhesive SBR are dissolved in deionized water in a ratio of 96.5:1.0:1.0:1.5 to obtain an anode paste, which is then evenly coated on a copper foil. The operations of drying, cold pressing, trimming, slicing, and slitting are performed, to obtain an anode plate.
III. manufacturing a cell and disposing the cell inside a casing

The cathode plate, the anode plate, and an isolating membrane are assembled into a cell using a winding process. The cell is then packaged with aluminum-plastic composite films and is dried in a vacuum environment.
IV. performing a first injection operation on the cell disposed inside the casing, where the first electrolyte used in the first injection operation has formulations as respectively shown in the comparative examples and experimental examples in Table 1.
V. infiltrating the cell for 10 h to 15 h under 40° C. to 50° C., further infiltrating the cell for 20 h to 30 h under room temperature, and then pre-charging the cell using a current of 0.05 C; the control conditions for pre-charging are: performing constant-current charging at a charging rate of 0.05 C, and setting the cut-off voltage to 3.4V. After the pre-charging, allowing the cell to stand for 12 h under 45° C.

In the pre-charging process, a gas extraction process is added to ensure that the gas generated during the pre-charging treatment is fully discharged. The vacuum degree of the casing is maintained within a range of −90 Kpa to −80 Kpa during the gas extraction process.
VI. performing a second injection operation on the cell disposed inside the casing, where the second electrolyte used in the second injection operation has formulations as respectively shown in the comparative examples and experimental examples in Table 1.

After injection of the second electrolyte, the cell is allowed to stand for 12 h, then capacity sorting is performed, to obtain a sodium-ion rechargeable battery composed of pouch cells and with a capacity of 3 Ah.

The performance of the sodium-ion rechargeable batteries manufactured according to the comparative examples and experimental examples is tested, and the testing process is as follows:
1. capacity retention test in cycling under 25° C.: at 25° C., performing constant-current charging on a sodium-ion rechargeable battery at a charging rate of 1 C to the upper-limit voltage, performing constant-voltage charging to a current of 0.05 C, and then performing constant-current discharging at a discharging rate of 1 C to the lower-limit voltage. Conducting 1000 cycles of charge and discharge testing, and recording the discharging capacity at the 1000th cycle. Capacity retention=(discharging capacity at the 1000th cycle÷discharge capacity at the first cycle)×100%, and recording the capacity retention at the 500th cycle.
2. capacity retention test in cycling under 45° C.: at 45° C., performing constant-current charging on a sodium-ion rechargeable battery at a charging rate of 1 C to the upper-limit voltage, performing constant-voltage charging to a current of 0.05 C, and then performing constant-current discharging at a discharging rate of 1 C to the lower-limit voltage. Conducting 1000 cycles of charge and discharge testing, and recording the discharging capacity at the 1000th cycle. Capacity retention=(discharging capacity at the 1000th cycle÷discharge capacity at the first cycle)×100%, and recording the capacity retention at the 500th cycle.
3. High-temperature storage performance test under 45° C.: at 45° C., performing constant-current charging on a sodium-ion rechargeable battery at a charging rate of 1 C to the upper-limit voltage, performing constant-voltage charging to a current of 0.05 C, and then performing constant-current discharging at a discharging rate of 1 C to the lower-limit voltage. Recording the discharge capacity in this test as an initial capacity C1, and recording the initial volume V1 and initial impedance F1 of the battery. Then performing constant-current charging at a charging rate of 1 C to the upper-limit voltage, and performing constant-voltage charging to a current of 0.05 C. Storing the fully charged battery under 45° C. for 15 days, and allowing the battery to stand for at least 2 hours under room temperature after storage. Then performing constant-current discharging at a discharging rate of 1 C to the lower-limit voltage, and recording the discharge capacity C2, and the after-storage volume V2 and after-storage impedance F2 of the battery. The capacity retention (%)=(C2÷C1)×100%. Then under room temperature, performing constant-current and constant-voltage charging on the battery at a charging rate of 1 C to the upper-limit voltage, cutting off at 0.05 C, and performing constant-current discharging at a discharging rate of 1 C to the lower-limit voltage. Recording the restoring capacity C3 and calculating the capacity restoring rate (%)=(C3÷C1)×100%. The internal resistance growth rate (%)=after-storage impedance F2÷initial impedance F1×100%. The gas growth rate (%)=(after-storage volume V2−initial volume V1)÷initial volume V1.

These testing methods aim to comprehensively evaluate the performance of the sodium-ion rechargeable batteries manufactured according to the embodiments and comparative examples.

TABLE 2

| | Capacity after | | Capacity after n | | | | | | |
|---|---|---|---|---|---|---|---|---|---|
| | cycles under | | cycles under | | 100% SOC storing for 30 days under 45° C. | | | | |
| Serial | 25° C. | | 45° C. | | | Capacity | Initial | Internal | Gas |
| number | % | % | % | % | Capacity | restoring | internal | resistance | growth |
| of | @500 | @1000 | @500 | @1000 | retention | rate | resistance | growth | rate |
| batteries | times | times | times | times | (%) | (%) | (mΩ) | rate (%) | (%) |
| D1 | 88.2 | 85.7 | 87.2 | 83.7 | 91.2 | 92.5 | 21.2 | 25.2 | 36.5 |
| D2 | 89.8 | 87.4 | 88.1 | 84.3 | 92.1 | 93.2 | 22.3 | 24.1 | 33.7 |
| D3 | 91.3 | 88.9 | 89.6 | 85.8 | 93.2 | 94.5 | 21.1 | 24.8 | 34.6 |
| D4 | 93.2 | 90.8 | 91.5 | 87.7 | 93.5 | 94.9 | 22.8 | 25.1 | 35.3 |
| D5 | 94.1 | 91.7 | 92.4 | 88.6 | 93.6 | 94.7 | 21.9 | 24.9 | 34.9 |
| D6 | 98.3 | 96.1 | 93.7 | 90.9 | 96.1 | 97.3 | 24.2 | 16.8 | 19.5 |
| D7 | 96.7 | 94.2 | 94.7 | 91.9 | 98.4 | 99.1 | 26.4 | 15.2 | 18.3 |
| E1 | 98.7 | 96.4 | 94.2 | 91.2 | 97.3 | 98.1 | 24.3 | 8.7 | 13.8 |
| E2 | 98.5 | 96.2 | 93.9 | 91.1 | 97.1 | 97.8 | 24.1 | 8.9 | 14.1 |
| E3 | 97.1 | 95.1 | 95.1 | 92.3 | 98.9 | 99.6 | 26.5 | 7.2 | 10.2 |
| E4 | 97 | 94.5 | 95 | 92.2 | 98.6 | 99.3 | 26.3 | 7.5 | 10.9 |

Table 2 shows the results of the performance tests on the sodium-ion rechargeable batteries manufactured according to the embodiments and comparative examples.

Referring to Table 2, the following comparative analysis can be derived:

According to the results of electrical performance tests of room-temperature cycles, high-temperature cycles, and high-temperature storage, the comparison between Comparative Example 1 and Comparative Example 2 shows that the dual-injection method has a positive effect on improving the capacity retention, high-temperature storage capacity retention, and high-temperature storage capacity restoring rate in the room-temperature cycles and high-temperature cycles, as well as on suppressing the growth of internal resistance and of gas generation. In particular, the dual-injection method significantly improves the capacity retention in the later stage of the cycles. This is associated with the targeted repair of the formed SEI films by the high-concentration PS in the second electrolyte.

The comparison between Comparative Example 3, Comparative Example 4, Comparative Example 5, and Comparative Example 2 shows that adding TMSP, FEC, or a mixture of FEC and TMSP separately to the first electrolyte is conducive to improvement of the capacity retention under room temperature (the temperature ranged from 20° C. to 25° C.) and high temperature, with FEC bringing a more significant improvement in capacity retention. This may be due to the fact that FEC can promote the formation of SEI films in the electrolyte, increase the density and stability of SEI films, thereby improving the cycling performance of the sodium-ion rechargeable batteries.

However, in the high-temperature storage tests, the improvement effect of these additives is not significant. This is consistent with the characteristics of TMSP and FEC. TMSP can form SEI films with low impedance and effectively reduce the initial internal resistance. FEC can improve the density and stability of the SEI films, which is conducive to improvement of cycling performance. The use of TMSP together with FEC can balance the advantages of them and provide better performance.

The comparison between Comparative Example 6, Comparative Example 7, and Comparative Example 5 shows that adding nitriles compound DENE or HTCN can significantly improve the capacity retention, high-temperature storage capacity retention, and high-temperature storage capacity restoring rate in the room-temperature cycles and high-temperature cycles, and can suppress the growth of internal resistance and of gas generation.

However, these two nitrile additives both increase internal resistance, especially HTCN. DENE has a more significant effect on improvement in the room-temperature cycles, and HTCN has a more prominent effect on the high-temperature cycles and high-temperature storage. This may be associated with the fact that HTCN has stronger ability to coordinate with high-valence transition metal ions on the surfaces of the cathode plate under high temperature, form stable complexes, and reduce side reactions and gas generation.

The comparison between Experimental Example 1, Experimental Example 2, Experimental Example 3, and Experimental Example 4 and the above comparative examples shows that the first electrolyte contains FEC, TMSP, and PS of first concentration, the second electrolyte contains PS of second concentration greater than the first concentration, and nitriles compound and water and acid removing additive (DCC or DIC) are added into the second electrolyte. In this way, the testing performance of the manufactured sodium-ion rechargeable batteries can be comprehensively improved, not only the capacity retention, high-temperature storage capacity retention, and high-temperature storage capacity restoring rate in the room-temperature cycles and high-temperature cycles can be improved, but also the growth of internal resistance and of gas generation can be effectively suppressed. Moreover, the sodium-ion rechargeable batteries can have a lower initial internal resistance.

From the above experimental data, it can be seen that the method for manufacturing sodium-ion rechargeable batteries provided in the embodiments of the present disclosure is conducive to improving the overall performance of the sodium-ion rechargeable batteries, addressing the problem of gas generation commonly found in sodium-ion batteries, and taking into account the long-cycle performance under high temperature and low temperature, thereby achieving comprehensive improvement in electrochemical performance.

Those having ordinary skill in the art shall understand that the above embodiments are exemplary implementations for realizing the present disclosure. In practice, any person skilled in the art to which the embodiments of the present disclosure belong may make any modifications and changes in forms and details without departing from the scope of the present disclosure. Therefore, the patent scope of protection of the present disclosure shall still be subject to the scope limited by the appended claims.

What is claimed is:

1. A method for manufacturing sodium-ion rechargeable batteries, comprising:
providing a cell and disposing the cell inside a casing;
performing a first injection operation on the cell disposed inside the casing using a first electrolyte, wherein the first electrolyte includes: 1,3-propanesultone of 0.5 wt % to 2 wt %, tris(trimethylsilyl) phosphate of 0.1 wt % to 2 wt %, fluoroethylene carbonate of 0.1 wt % to 2 wt %, a film forming additive of 0.01 wt % to 5 wt %, and at least one sodium salt;
performing infiltration treatment and pre-charging treatment on the cell;
performing a second injection operation on the cell disposed inside the casing using a second electrolyte, wherein the second electrolyte includes: 1,3-propanesultone of 5 wt % to 20 wt %, a nitriles compound of 3 wt % to 30 wt %, a water and acid removing additive of 0.005 wt % to 30 wt %, and at least one sodium salt; and
allowing the cell to stand for at least a predetermined amount of time;
wherein the cell includes a cathode plate, an anode plate, and an isolating membrane disposed between the cathode plate and the anode plate;
wherein the cathode plate, the isolating membrane, and the anode plate are stacked to form the one respective cell, or are stacked and wound to form the cell;
wherein the cathode plate includes a cathode current collector and at least one cathode active material layer disposed on the cathode current collector, and the anode plate includes an anode current collector and at least one anode active material layer disposed on the anode current collector; and
wherein the at least one cathode active material layer includes a layered oxide cathode material, a polyanionic cathode material, or a Prussian blue cathode material, and the at least one anode active material layer includes a metal compound, a carbon-based material, an alloy material, or a non-metallic simple substance.

2. The method according to claim 1, wherein mass of the 1,3-propanesultone in the second electrolyte and mass of the 1,3-propanesultone in the first electrolyte meets:
$$40 \% \times M \leq m 1 \leq 50 \% \times M ; \\ 50 \% \times M \leq m 2 \leq 60 \% \times M ; and \\ M = m 1 + m 2 ;$$
wherein m1 refers to the mass of the 1,3-propanesultone in the first electrolyte, and m2 refers to the mass of the 1,3-propanesultone in the second electrolyte.

3. The method according to claim 1, wherein the second electrolyte includes the nitriles compound of 10 wt % to 25 wt % and the water and acid removing additive of 5 wt % to 10 wt %.

4. The method according to claim 1, wherein the nitriles compound includes a dinitriles compound, a trinitriles compound, an unsaturated nitriles compound, an aromatic-ring-containing nitriles compound, an alkoxynitriles compound, a sulfonyl-containing nitriles compound, or a trimethylsilyl-containing nitriles compound.

5. The method according to claim 3, wherein the nitriles compound includes a dinitriles compound, a trinitriles compound, an unsaturated nitriles compound, an aromatic-ring-containing nitriles compound, an alkoxynitriles compound, a sulfonyl-containing nitriles compound, or a trimethylsilyl-containing nitriles compound.

6. The method according to claim 4, wherein:
the dinitriles compound includes succinonitrile, adiponitrile, glutaronitrile, suberonitrile, or sebaconitrile;
the trinitriles compound includes 1,3,6-hexanetricarbonitrile or 1,3,5-pentanetetricarbonitrile;
the unsaturated nitriles compound includes acrylonitrile, crotononitrile, trans-butenedinitrile, or 1,4-dicyanobutene;
the aromatic-ring-containing nitriles compound includes 4-fluorobenzonitrile, 4-methylbenzonitrile, or tricyanobenzene;
the alkoxynitriles compound includes 1,2-di(cyanoethoxy)ethane, or 1,2,3-tris(cyanoethoxy)propane;
the sulfonyl-containing nitriles compound includes sulfolane dinitrile; and
the trimethylsilyl-containing nitriles compound includes 3-(trimethylsilyloxy)propionitrile.

7. The method according to claim 5, wherein:
the dinitriles compound includes succinonitrile, adiponitrile, glutaronitrile, suberonitrile, or sebaconitrile;
the trinitriles compound includes 1,3,6-hexanetricarbonitrile or 1,3,5-pentanetetricarbonitrile;
the unsaturated nitriles compound includes acrylonitrile, crotononitrile, trans-butenedinitrile, or 1,4-dicyanobutene;
the aromatic-ring-containing nitriles compound includes 4-fluorobenzonitrile, 4-methylbenzonitrile, or tricyanobenzene;
the alkoxynitriles compound includes 1,2-di(cyanoethoxy)ethane, or 1,2,3-tris(cyanoethoxy)propane;
the sulfonyl-containing nitriles compound includes sulfolane dinitrile; and
the trimethylsilyl-containing nitriles compound includes 3-(trimethylsilyloxy)propionitrile.

8. The method according to claim 1, wherein the water and acid removing additive includes a carbodiimide compound, a silazane compound, an amine compound, methanesulfonyl chloride, tetrahydrofuran, or trifluoroacetic anhydride.

9. The method according to claim 3, wherein the water and acid removing additive includes a carbodiimide compound, a silazane compound, an amine compound, methanesulfonyl chloride, tetrahydrofuran, or trifluoroacetic anhydride.

10. The method according to claim 8, wherein:
the carbodiimide compound includes dicyclohexylcarbodiimide or diisopropylcarbodiimide;
the silazane compound includes hexamethyldisilazane, heptamethyldisilazane, or trimethylchlorosilane; and
the amine compound includes triethylamine or diethylamine.

11. The method according to claim 9, wherein:
the carbodiimide compound includes dicyclohexylcarbodiimide or diisopropylcarbodiimide;
the silazane compound includes hexamethyldisilazane, heptamethyldisilazane, or trimethylchlorosilane; and
the amine compound includes triethylamine or diethylamine.

12. The method according to claim 1, wherein a ratio of mass of the first electrolyte to a sum of the mass of the first electrolyte and mass of the second electrolyte ranges from 65% to 90%.

13. The method according to claim 1, wherein the infiltration treatment includes a first infiltration stage and a second infiltration stage, a temperature for the first infiltration stage is greater than a temperature for the second infiltration stage, and a duration of the first infiltration stage is less than a duration of the second infiltration stage;
wherein the temperature for the first infiltration stage ranges from 40° C. to 50° C., and the duration of the first infiltration stage ranges from 10 h to 15 h; and
wherein the temperature for the second infiltration stage ranges from 15° C. to 25° C., and the duration of the second infiltration stage ranges from 20 h to 30 h.

14. The method according to claim 1, wherein the pre-charging treatment includes:
performing constant-current charging at a charging rate ranged from 0.04 C to 0.06 C; and
ending the pre-charging treatment at a voltage of 3.4V.

15. The method according to claim 1, wherein during the pre-charging treatment, the method further includes: performing gas extraction from the casing.

16. The method according to claim 1, wherein the first electrolyte includes the film forming additive of 0.5 wt % to 3 wt %.

17. The method according to claim 1, wherein the second electrolyte further includes a functional additive of 0 wt % to 2 wt %, and the functional additive includes the film forming additive or a gas inhibiting additive.

18. The method according to claim 17, wherein the functional additive includes at least one of sodium difluorooxalatoborate, sodium difluorophosphate, sodium bis(oxalato)borate, methane disulfonate, ethylene sulfate, triallyl phosphate, tripropargyl phosphate, 1,3-propene sultone, fluorobenzene, trifluoroethoxyvinyl carbonate, 2-methyl maleic anhydride, di-fluoro ethylene carbonate, succinic anhydride, tris(trimethylsilyl) phosphate, ethylene sulfite, or 1,6-diisocyanatohexane hexamethylene diisocyanate.

19. The method according to claim 1, wherein the at least one sodium salt is select from a group of: sodium hexafluorophosphate, sodium perchlorate, sodium tetrafluoroborate, sodium hexafluoroarsenate, sodium tetrachloroaluminate, sodium trifluoroacetate, sodium tetraphenylborate, sodium difluorophosphate, sodium bis(oxalato)borate, sodium difluorooxalatoborate, sodium trifluoromethanesulfonate, sodium bis(fluorosulfonyl)imide, and sodium bis(trifluoromethanesulfonyl)imide.

20. The method according to claim 1, wherein the isolating membrane includes at least one of polypropylene, polyethylene, ceramic coating, or non-woven fabrics.
